(19) United States
(12) Patent Application Publication
(10) Pub. No.: US 2014/0310616 A1
(43) Pub. Date: Oct. 16, 2014

(54) SYSTEM FOR INTERACTIVE COMMUNICATION

(71) Applicant: Artashes Valeryevich IKONOMOV, Moscow (RU)

(72) Inventor: Artashes Valeryevich Ikonomov, Moscow (RU)

(21) Appl. No.: 14/354,099

(22) PCT Filed: May 8, 2013
(86) PCT No.: PCT/RU2013/000387

§ 371 Date: Apr. 24, 2014

(30) Foreign Application Priority Data
May 18, 2012 (RU) 2012120567

(51) Int. Cl. H04L 12/58; G06F 3/0482

(52) U.S. Cl. CPC H04L 51/046; G06F 3/0482
USPC 715/753

(57) ABSTRACT

The present utility model relates to communications systems, specifically to systems for interactive communication comprising client devices interconnected by means of a unified network comprising at least one server, and can be used in modern systems for interactive communication such as social networks and others which provide for the receipt and transmission of propositions requiring a response.

According to the utility model, each client device additionally comprises a settings unit for the receipt of incoming propositions and a unit of response to incoming propositions which are connected to an incoming propositions receipt unit and incoming propositions display unit.

The technical result is a broadening of functional capabilities and an increase in convenience of use.

The present utility model relates to communications systems, specifically to systems for interactive communication comprising client devices interconnected by means of a unified network comprised of at least one server, and can be used in modern systems for interactive communication such as social networks and others which provide for the receipt and transmission of propositions requiring a response.

Modern systems for interactive communication such as social networks and others which provide for the receipt and transmission of propositions requiring a response employ a binary logic response in visualizing the incoming propositions, i.e. accept or decline. In particular, such solution is implemented in social networks wherein friendships, relationships and the like are usually initiated by sending a respective request.

The known example of prior art is a system for interactive communication described in the Russian utility model patent No 114185, published in 2012, and comprising client devices interconnected by means of a unified network comprising at least one server. The system for interactive communication is presented as a social business network and comprises personal computers of the users connected to the Internet and having a personal access key, and related data storage and processing servers with databases.

The known solution has a drawback, namely, the fact that the incoming propositions are settled into the user interface of the system for interactive communication with the help of two possible options of response on the incoming propositions: accept it, or decline it. The incoming proposition will be active in the interface proposition list for as long as the user responds to said proposition. The incoming propositions are, in fact, not filtered or blocked, cluttering the list of incoming propositions. Very often users fail to respond to the same in time, so these propositions remain pending for a long time.

Another known example of prior art is a system for interactive communication described in the Russian utility model patent No 2331913, published in 2006, and comprising client devices interconnected by means of a unified network comprising at least one server, wherein each of said client devices comprises interconnected incoming propositions receipt unit and incoming propositions display unit. The system for interactive communication is built as a feedback circuit to prevent unauthorized messaging, said circuit comprising: a component for the receipt of a set of elements; a component for identifying intended recipients of the elements and marking the subset of elements for inquiry, wherein said subset of elements correlates with the subset of users, said users being known users who act against unauthorized messaging; and a feedback component to receive the information related to the classification of elements by the user who acts against unauthorized messaging as the result of such inquiry, and to use said information to train the unauthorized messaging filter and complete the list of unauthorized messaging.

The above device is used herein as a prototype of the claimed utility model.

The known solution has a drawback, namely, the fact that the incoming propositions are settled into the user interface of the system for interactive communication with the help of two possible options of response on the incoming propositions: accept it, or decline it. Said device has no multiple options of response to the incoming propositions.

The present utility model relies on this novel observation with the primary aim to offer a system for interactive communication that could at least mitigate one of the above drawbacks, namely by solving an issue of filtering/sorting the incoming proposition and due response to them, which serves to broaden of functional capabilities and increase the convenience of use of the system for interactive communication.

For this purpose, each client device additionally comprises a settings unit for the receipt of incoming propositions and a unit of response to incoming propositions, which are connected to the incoming propositions receipt unit and the incoming propositions display unit.

The above makes it possible to solve the issue of filtering/sorting the incoming propositions and due response to them; for this purpose it is introduced in the system for communication a pattern of modes of the user's communication device to determine manual or automatic response of the user of the system for communication to the incoming propositions.

A version of the utility model includes the settings unit for the receipt of incoming propositions which has a device for switching to one of the three communication modes: accept all incoming propositions; do not accept all incoming propositions and remove them from the list of incoming propositions; do not accept all incoming propositions and include them in the list of incoming propositions.

The above makes it possible for the system to function in one of the above modes.

A version of the utility model includes the unit of response to incoming propositions has a device having two response modes: notification of acceptance of the proposition selected from the list of propositions; notification of decline of the proposition selected from the list of propositions.

The above makes it possible to initiate a variety of responses to incoming propositions in an automatic mode.

The combination of the essential features of the claimed utility model is not known from the prior art, therefore the utility model possesses the required feature of novelty.

Other distinguishing features and advantages of the utility model are readily apparent from the description below, which includes for illustration but is not limited to the following features, with references to the figure attached:

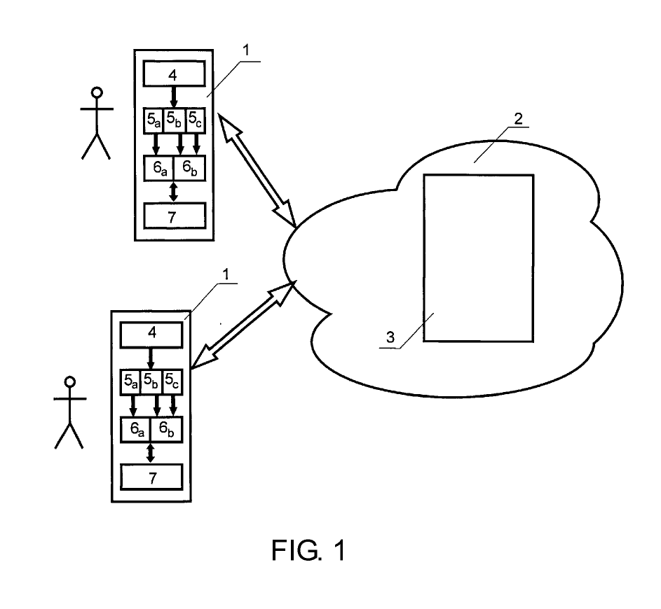

FIG. 1 schematically shows a block diagram of a system for interactive communication.

A system for interactive communication comprises client devices 1 connected to a unified network 2 that includes at least one server 3. The client device 1 comprises the following series-connected components:

incoming propositions receipt unit 4;

settings unit for the receipt of incoming propositions 5;

unit of response to incoming propositions 6;

incoming propositions display unit 7.

In general, any variety of computing platforms that can be connected to a network such as a unified network and can interact with applications can be a client device 1. Standard examples of some such client devices include but are not limited to desktop and laptop personal computers, smart cellular phones, lightweight clients, workstations, “non-intelligent” terminals connected to the application server and various combinations and configurations of the same that are self-evident for those skilled in the art, i.e. these include both physical devices that ensure interaction as part of communication and virtual devices based on programmable computers and having no program interface to enable such communication.

The unified network 2 comprises a multitude of topologies, configurations and arrangements of the internetworking components built so as to connect corporate, global and local computer networks. Such network includes but is not limited to traditional wired and wireless, satellite, optical and equivalent networking technology that are self-evident for those skilled in the art.

The settings unit for the receipt of incoming propositions 5 has a device for switching the system for interactive communication to one of the three communication modes: accept all incoming propositions 5a; do not accept all incoming propositions and remove them from the list of incoming propositions 5b; do not accept all incoming no propositions and include them in the list of incoming propositions 5c.

The unit of response to incoming propositions 6 has a device having two response modes: notification of acceptance of the proposition selected from the list of propositions 6a; notification of decline of the proposition selected from the list of proposition 6b.

The utility model functions as follows.

Upon receipt of an incoming proposition by the client device 1, the user filters incoming messages with the help of the settings unit for the receipt of incoming propositions 5 and sets one of the three messages receipt modes:

a) accept all incoming propositions;

b) do not accept all incoming propositions and remove them from the list of incoming propositions;

c) do not accept all incoming propositions and include them in the list of incoming propositions.

The incoming propositions receipt unit 4 acts in different ways toward the incoming propositions depending on the mode selected by the settings unit for the receipt of incoming propositions 5.

If “Accept all incoming propositions” is selected, the incoming propositions receipt unit 4 saves and registers all incoming propositions with no restrictions as to the list of incoming propositions.

If “Do not accept all incoming propositions and remove them from the list of incoming propositions” is selected, the incoming propositions receipt unit 4 refers to the unit of response to incoming propositions 6 and instructs the latter to automatically generate an automatic message to the original sender in form of “Your request is declined” that may or may not specify the grounds for such decline.

If “Do not accept all incoming propositions and include them in the list of incoming propositions” is selected, the incoming propositions receipt unit 4 saves and registers the incoming propositions, then refers to the unit of response to incoming propositions 6 and instructs the latter to automatically generate an automatic message to the original sender in form of “Your request is declined” that may or may not specify the grounds for such decline.

The unit of response to incoming propositions 6 identifies the sender of the incoming proposition and delivers a response of the said form to such sender.

The incoming propositions display unit 7 displays all registered and saved incoming propositions and offers interactive response options for each proposition in the list of propositions.

The incoming propositions display unit 7 refers to the unit of response to incoming propositions 6 and instructs the latter to send:

a) a notification of acceptance of the proposition selected from the list of propositions;

b) a notification of decline of the proposition selected from the list of propositions.

This is the way the system functions to filter and discard the unwanted propositions and to generate an automatic response in due time.

The above description of exemplary versions of the utility model serves to illustrate and characterize said model, but is not meant to be taken as an exhaustive description or a limitation of the utility models by the described exact versions. The above description allows for modifications and alterations that can also be derived from the use of the utility model.

Persons skilled in the art also understand that the utility model components as described above may be incorporated in a multitude of software varieties, built-in applications and hardware in their respective versions as shown in the diagram. Any actual program code or specialized hardware control used for materialization of the objects in accordance with the basic principles of said utility model do not serve to limit the utility model. Therefore, the utility model components and their functionality have been described herein without reference to a specific program code, as it is evident that a person skilled in the art is capable of developing software and controlling hardware to implement such components based on the description as given herein.

A system for interactive communication in the environment of the Cafe4tune social network has been made in accordance with the claimed utility model. Trial runs of said system for interactive communication demonstrated that it serves to filter/sort the incoming propositions and respond to the same in due time, thus achieving the claimed technical result of broadening of functional capabilities and an increase in convenience of use of the system for interactive communication.

1. System for interactive communication comprising client devices interconnected by means of a unified network comprising at least one server, wherein each client device comprises:
an incoming proposition receipt unit,
an incoming propositions display unit, the incoming proposition receipt unit and the incoming propositions display unit being interconnected,
a settings unit for the receipt of incoming propositions connected to the incoming propositions receipt unit and to the incoming propositions display unit, and
a unit of response to incoming propositions connected to the incoming propositions receipt unit and to the incoming propositions display unit.

2. System for interactive communication according to claim 1, wherein said settings unit for the receipt of incoming propositions has a device for switching to one of the three communication modes: (a) accept all incoming propositions; (b) do not accept all incoming propositions and remove them from the list of incoming propositions; (c) do not accept all incoming propositions and include them in the list of incoming propositions.

3. System for interactive communication according to claim 1, wherein said unit of response to incoming propositions has a device having two response modes: (a) notification of acceptance of the proposition selected from the list of propositions; (b) notification of decline of the proposition selected from the list of propositions.

4. System for interactive communication according to claim 2, wherein the incoming propositions display unit is adapted:
to display all incoming propositions registered and saved by the incoming proposition receipt unit, and
to offer interactive response options for each proposition in the list of propositions with the help of the unit of response to incoming propositions,
wherein said unit of response to incoming propositions has a device having two response modes: (a) notification of acceptance of the proposition selected from the list of propositions; (b) notification of decline of the proposition selected from the list of propositions.

5. System for interactive communication according to claim 1, wherein the incoming proposition receipt unit, the incoming propositions display unit, the settings unit for the receipt of incoming propositions and the unit of response to incoming propositions are connected in series.

6. Method of use of a system for interactive communication comprising client devices interconnected by means of a unified network comprising at least one server, each client device comprising:
an incoming proposition receipt unit,
an incoming propositions display unit, the incoming proposition receipt unit and the incoming propositions display unit being interconnected,
a settings unit for the receipt of incoming propositions connected to the incoming propositions receipt unit and to the incoming propositions display unit, and
a unit of response to incoming propositions connected to the incoming propositions receipt unit and to the incoming propositions display unit,
wherein the method of use comprises:
receiving by the client device of an incoming proposition,
filtering incoming messages with the help of the settings unit for the receipt of incoming propositions by switching to one of the three communication modes:
a first communication mode being adapted to accept all incoming propositions;
a second communication mode being adapted to:
do not accept all incoming propositions and
remove them from the list of incoming propositions;
a third communication mode being adapted to:
do not accept all incoming propositions and
include them in the list of incoming propositions,
acting of the incoming propositions receipt unit in different ways toward the incoming propositions depending on the communication mode selected by the settings unit for the receipt of incoming propositions.

7. Method of use according to claim 6, wherein the incoming propositions receipt unit saves and registers all incoming propositions with no restrictions as to the list of incoming propositions if the first communication mode is selected.

8. Method of use according to claim 6, wherein the incoming propositions receipt unit refers to the unit of response to incoming propositions and instructs the unit of response to incoming propositions to automatically generate an automatic message of decline if the second communication mode is selected.

9. Method of use according to claim 8, wherein the unit of response to incoming propositions specifies grounds for such decline in the automatic message of decline.

10. Method of use according to claim 8, wherein the unit of response to incoming propositions identifies a sender of the incoming proposition and delivers the automatic message of decline to this sender.

11. Method of use according to claim 6, wherein the incoming propositions receipt unit:
saves and registers the incoming propositions,
refers to the unit of response to incoming propositions and
instructs the unit of response to incoming propositions to automatically generate an automatic message of decline,
if the third communication mode is selected.

12. Method of use according to claim 11, wherein the unit of response to incoming propositions specifies grounds for such decline in the automatic message of decline.

13. Method of use according to claim 8, wherein the unit of response to incoming propositions identifies a sender of the incoming proposition and delivers the automatic message of decline to this sender.

14. Method of use according to claim 7, wherein the incoming propositions display unit:
displays all incoming propositions registered and saved by the incoming proposition receipt unit and
offers interactive response options for each proposition in the list of propositions with the help of the unit of response to incoming propositions.

15. Method of use according to claim 11, wherein the incoming propositions display unit:
displays all incoming propositions registered and saved by the incoming proposition receipt unit and
offers interactive response options for each proposition in the list of propositions with the help of the unit of response to incoming propositions.

16. Method of use according to claim 14, wherein the unit of response to incoming propositions has a device having two response modes:
a first response mode adapted to sending a notification of acceptance of the proposition selected from the list of propositions;
a second response mode adapted to sending a notification of decline of the proposition selected from the list of propositions.

17. Method of use according to claim 15, wherein the unit of response to incoming propositions has a device having two response modes:
a first response mode adapted to sending a notification of acceptance of the proposition selected from the list of propositions;
a second response mode adapted to sending a notification of decline of the proposition selected from the list of propositions.

18. Method of use according to claim 16, wherein the incoming proposition receipt unit, the incoming propositions display unit, the settings unit for the receipt of incoming propositions and the unit of response to incoming propositions are connected in series.

19. Method of use according to claim 17, wherein the incoming proposition receipt unit, the incoming propositions display unit, the settings unit for the receipt of incoming propositions and the unit of response to incoming propositions are connected in series.

20. Method of use according to claim 8, wherein the incoming proposition receipt unit, the incoming propositions display unit, the settings unit for the receipt of incoming propositions and the unit of response to incoming propositions are connected in series.
